(19) United States
(12) Patent Application Publication
(10) Pub. No.: US 2012/0265883 A1
(43) Pub. Date: Oct. 18, 2012

(54) MULTIPLE OVERLAPPING BLOCK TRANSFERS

(75) Inventor: Dennis C. Abts, Eleva, WI (US)

(73) Assignee: Cray Inc., Seattle, WA (US)

(21) Appl. No.: 13/448,126

(22) Filed: Apr. 16, 2012

Related U.S. Application Data
(63) Continuation of application No. 12/174,226, filed on Jul. 16, 2008, now abandoned.

(51) Int. Cl. G06F 15/173

(52) U.S. Cl. 709/226

(57) ABSTRACT

A computerized system comprising multiple processing nodes, a physical channel configured to transfer data between a memory local to a processing node and a network target remote from the processing node, and a block transfer engine configured to allocate multiple virtual channels to the physical channel and to transfer multiple address-overlapping blocks of data simultaneously using the virtual channels.

### CROSS-REFERENCE TO RELATED APPLICATION(S)

This application is a continuation of U.S. patent application Ser. No. 12/174,226 filed Jul. 16, 2008, entitled MULTIPLE OVERLAPPING BLOCK TRANSFERS, which is incorporated herein by reference in its entirety.

### BACKGROUND

Computerized systems typically rely on network connections to transfer data, whether from one computer system to another computer system, one computer component to another computer component, or from one processor to another processor in the same computer. Most computer networks link multiple computerized elements to one another, and include various functions such as verification that a message or other data sent over the network arrived at the intended recipient, confirmation of the integrity of the data, and a method of routing a message to the intended recipient on the network.

These and other basic network functions are used to ensure that a message or data sent via a computerized network reaches the intended recipient intact. When networks are congested, messages may not be forwarded through the network efficiently and reach the intended destination in a timely manner or in the order sent. Various problems such as broken routing links, deadlocks, livelocks, and message prioritization can result in some messages being delayed, rerouted, or in extreme cases failing to arrive at the intended destination altogether.

Similarly, when networks become noisy, or when a network connection is faulty, network messages can be lost and not reach the intended destination, and transfers of large blocks of data may become delayed. This is commonly due to physical factors like electrical noise, poor connections, broken or damaged wires, impedance mismatches between network components, and other such factors.

For these and other reasons, many computerized networks implement various forms of flow control, such as requiring acknowledgment that a first packet or message in a sequence of packets or messages has been received by the intended recipient before sending the second packet or message. Sometimes, packet transmissions are prioritized so that more urgent data is transmitted with a higher priority when the network becomes congested or faulty.

It is desired to provide fast, reliable, and efficient messaging between elements in a computerized network.

### SUMMARY

This document discusses, among other things, apparatuses, systems, and methods for moving data within a computerized system. A system example includes a plurality of processing nodes, a physical channel configured to transfer data between a memory local to a processing node and a network target remote from the processing node, and a block transfer engine configured to allocate a plurality of virtual channels to the physical channel and to transfer a plurality of address-overlapping blocks of data simultaneously using the virtual channels.

A method example includes providing a physical channel to transfer data between a memory local to a processing node and a target remote from the processing node, allocating a plurality of virtual channels to the physical channel, and asynchronously and simultaneously transferring a plurality of address-overlapping blocks of data to the target using the virtual channels.

This overview is intended to provide an overview of the subject matter of the present patent application. It is not intended to provide an exclusive or exhaustive explanation of the invention. The detailed description is included to provide further information about the subject matter of the present patent application.

### BRIEF DESCRIPTION OF THE DRAWINGS

FIG. 1 is a block diagram of portions of an embodiment of a computerized system.

FIG. 2 is a block diagram of portions of an embodiment of a Block Transfer Engine.

FIG. 3 is flow diagram of an embodiment of a method of moving data in a computerized system.

### DETAILED DESCRIPTION

In the following detailed description, reference is made to the accompanying drawings which form a part hereof, and specific embodiments in which the invention may be practiced are shown by way of illustration. It is to be understood that other embodiments may be used and structural or logical changes may be made without departing from the scope of the present invention.

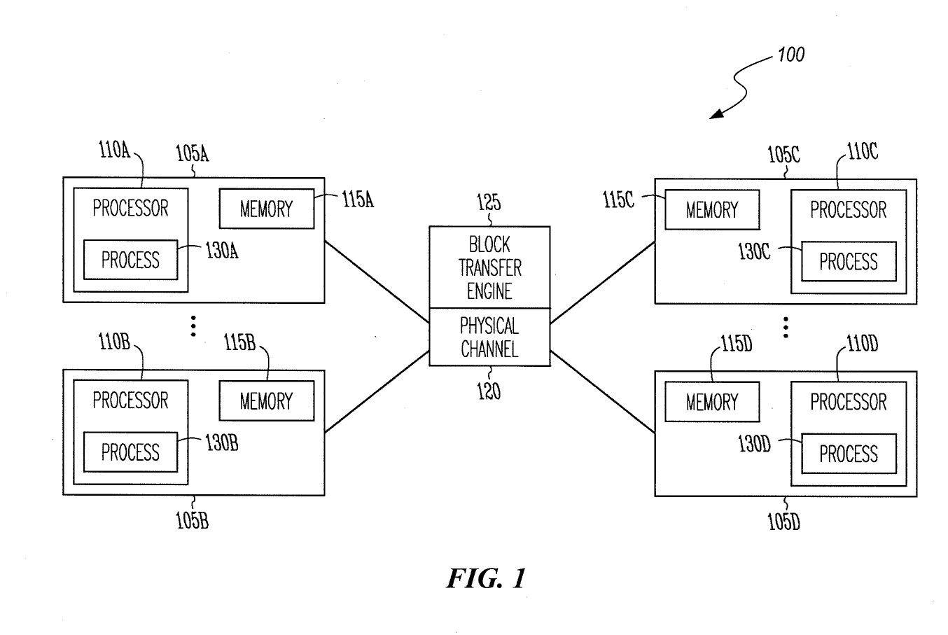

FIG. 1 is a block diagram of portions of an embodiment of a computerized system 100. The computerized system 100 comprises a plurality of processing nodes 105A-105D. The computerized system 100 may include thousands of processing nodes 105A-105D. A processing node 105A includes a processor 110A and a memory local to the processing node 105A (local memory 115A). The computerized system 100 includes a physical channel 120 to transfer data between a memory local to a processing node 105A and a network target remote from the processing node 105A. The network target may be memory local to another processing node 105B. The network target may be a system global memory that is remote to all the processing nodes 105A-105D.

The physical channel 120 is part of the interconnection network of the multiprocessor system. In some embodiments, the interconnection network includes a hypercube topology. In some embodiments, the interconnection network includes a CLOS topology. In some embodiments, the interconnection network includes a folded CLOS topology. In some embodiments, the interconnection network includes a butterfly topology.

The computerized system 100 includes a Block Transfer Engine (BTE) 125. The BTE 125 supports asynchronous block transfers over the physical channel between a local memory 115A and the remote network target. The BTE is programmed by a local processor to move data asynchronously between local and remote memory. Because of overhead in using the BTE 125, the BTE 125 may be more useful for large, asynchronous data block transfers between processing nodes 105A-105D. The asynchronous block transfers include privileged memory-to-memory copies of data between processing nodes 105A-105D, such as a Remote Direct Memory Access (RDMA) put/get style of transfers. The asynchronous transfers also include privileged messages between processing nodes 105A-105D, such as send/receive style inter-process communication mechanisms.

The BTE 125 allocates a plurality of virtual channels to the physical channel 120. A virtual channel is a communication channel that timeshares the physical channel 120 with other virtual channels. Each virtual channel includes its own buffers to avoid transfer deadlock. This allows the BTE 125 to transfer a plurality of address-overlapping blocks of data simultaneously (e.g., in parallel) using the virtual channels, while reducing the occurrences of channel lock out.

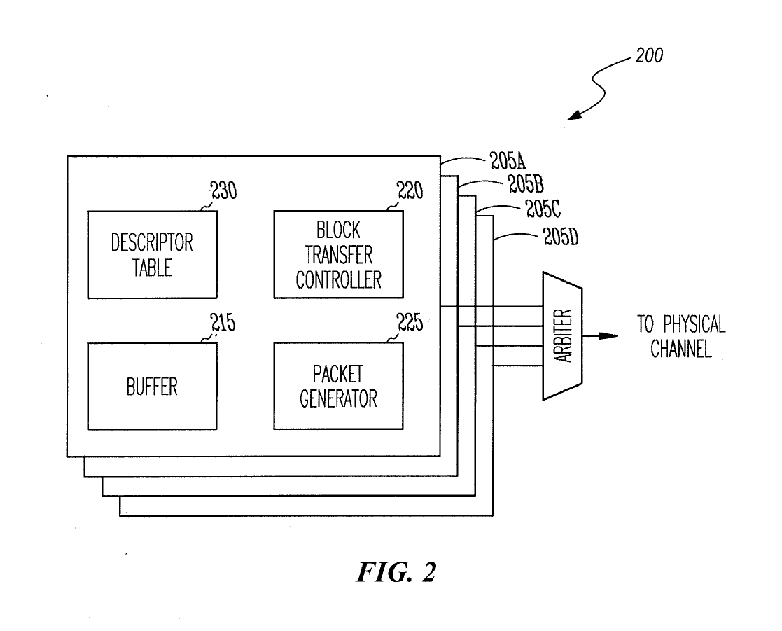

FIG. 2 is a block diagram of portions of an embodiment of a BTE 200. The BTE 200 includes a plurality of virtual channels 205A-205D. The example embodiment shown includes four virtual channels. In some embodiments, the BTE 200 may include an arbiter 210 to arbitrate access of the virtual channels 205A-205D to the physical channel.

If a virtual channel 205A has to wait for access to the physical channel, the virtual channel 205A may receive another request to transfer data. The virtual channel 205A includes at least one virtual channel buffer 215 to store data associated with a request for access to the virtual channel 205A when the virtual channel 205A receives simultaneous requests for such access.

The BTE 200 includes a block transfer controller (BTC) 220. In some embodiments, the BTC 220 is a state machine that governs remote memory transfers. The BTE 200 also includes a packet generator 225 to create packets for transmission to a remote target. A message sent by the BTE 200 may include a set of request packets that include one or more of a destination node, an address, a command, a tag, and a source node. If the message is a PUT message, the message includes packets that contain data. Each virtual channel 205A-205D within the BTE 200 may be assigned a unique identifier (ID). A message may include the virtual channel ID and an address within the virtual channel buffer 215.

In some embodiments, the BTE 200 allocates at least one of a BTC 220 or a packet generator to each virtual channel 205A-205D. If each virtual channel 205A-205D is allocated a block transfer controller and a packet generator, the BTE may complete the block transfers in a sequence different from a sequence in which the block transfers were initiated. In some embodiments, the BTE 200 allocates a BTC 220 or a packet generator 225 to more than one virtual channel 205A-205D. Thus, there may be more virtual channels than there are BTCs 220 or packet generators 225.

According to some embodiments, the BTE 200 includes one or more channel descriptor tables 230. In some embodiments, each virtual channel 205A-205D includes a channel descriptor table 230. In some embodiments, a channel descriptor table 230 is partitioned among more than one virtual channel 205A-205D.

In some embodiments, the channel descriptor table 230 includes transmit (TX) and receive (RX) channel descriptors. These may be organized into a TX descriptor table and a RX descriptor table within the channel descriptor table 230. The TX and RX channel descriptors are entries in the channel descriptor table 230 that are used to describe virtual channel transfers. For example, if the network target of a transfer includes a memory remote from a processing node, the BTE 200 asynchronously transfers respective blocks of data over respective virtual channels 205A-205D between the processing node and the remote memory according to TX and RX channel descriptors in respective channel descriptor tables 230. Use of the virtual channels 205A-205D allows address ranges of the blocks of the data transferred according to the descriptor table 230 to overlap in the remote memory.

The TX and RX channel descriptors may be used to configure a virtual channel 205A. For example, the TX and RX channel descriptors may be used to reset a virtual channel 205A, such as by initializing descriptor indices. The channel descriptors may also be used to enable data length checking on incoming messages to ensure that the data length does not exceed the size of a receive buffer, specify a maximum time for processing a message, and/or enable aggregation of message interrupts. In some embodiments, when aggregating interrupts, pending interrupt requests are accumulated during a specified time period and delivered as a single interrupt.

If each virtual channel 205A-205D includes a channel descriptor table 230, a virtual channel 205A is configured with the channel descriptor table 230. If a channel transfer descriptor table 230 is partitioned among the virtual channels 205A-205D, a respective virtual channel 205A may be configured with a respective channel transfer descriptor table partition.

The BTE 200 includes a TX queue (not shown) for each virtual channel 205A-205D. In some embodiments, the TX queue is implemented as a circular buffer. A TX descriptor configures the TX message, and the BTE 200 consumes a TX descriptor when processing a TX message. TX descriptors are consumed by the BTE 200 at the beginning or front of the TX queue. An application or process running on a processing node formulates a TX descriptor and adds it to the end of the queue. Thus, the channel descriptor table 230 may be accessed by the BTE 200 or by a process. In some examples, the TX descriptor may specify the type of transfer (e.g., SEND, PUT, or GET), and specify a type of routing (e.g., adaptive routing) for the message.

As with the TX queue, the BTE 200 includes a RX queue (not shown) for each virtual channel 205A-205D. The RX queue is used for posting (e.g., reserving or allocating) buffers to receive incoming data on remote target nodes in the computer system. An RX descriptor may specify the length of data in the message and/or may specify an address in the receiving buffer.

In some embodiments, the computerized system 100 of FIG. 1 includes multiple processes to execute on multiple processing nodes. For example, the computerized system 100 may include a first process 130A at a processing node 105A and a second process 130C at a network target, such as a second processing node 105C. The BTE 125 transfers data associated with a message from the first process 130A to the second process 130C using a virtual channel. The first process 130A and the second process 130C may be kernel processes running on their respective processing nodes 105A, 105C and the message may be an inter-kernel message.

The sender process or first process 130A may specify an address of the source data in local memory 115A and a target network endpoint (e.g., local memory 115C), but may not specify a target address at the network endpoint. The BTE 125 transfers the data associated with the message to the target network endpoint using a virtual channel.

The receiving or second process 130C pre-allocates one or more buffers to receive the data associated with the message. The virtual channel of the BTE 125 used in the transfer places the data in the pre-allocated buffers according to the RX descriptor for the message. If no buffer has been allocated when the data arrives at the network target, the virtual channel drops the data; the data is not written and is lost.

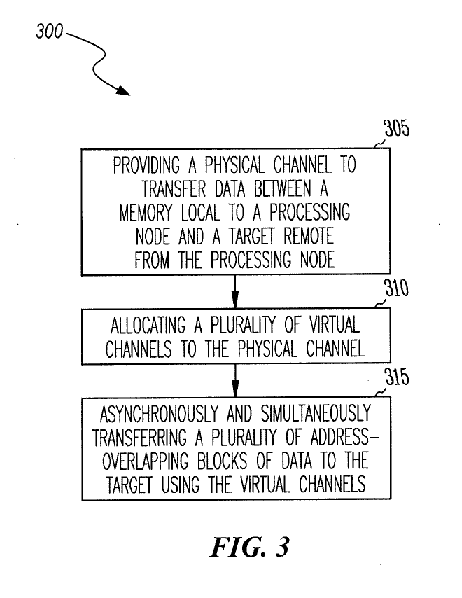

FIG. 3 is flow diagram of an embodiment of a method 300 of moving data in a computerized system. At block 305, a physical channel is provided to transfer data between a memory local to a processing node and a target remote from the processing node. In some embodiments, the target is another processing node. In some embodiments, the target is a system global memory. At block 310, a plurality of virtual channels are allocated to the physical channel. At block 315, a plurality of address-overlapping blocks of data are asynchronously and simultaneously transferred to the target using the virtual channels. In some embodiments, transferring data asynchronously includes asynchronously transferring data for inter-kernel messaging in a multi-kernel system.

In some embodiments, asynchronously transferring data for inter-kernel messaging includes placing data associated with a kernel message into a pre-allocated buffer at the target. The data may be pre-allocated by posting a buffer in a receive queue of a descriptor table used to describe transfers over the virtual channels. A descriptor entry in the receive queue may indicate a network endpoint as the target of the message instead of a target address. Data arriving at the network may be dropped if no buffer is posted when the data arrives at the target.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations, or variations, or combinations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own.

I/We claim:

1. A computerized system comprising:
a plurality of processing nodes;
a physical channel communicatively coupled to the processing nodes, wherein data is transferred between a memory local to a first processing node and a network target remote from the processing node using the physical channel; and
a block transfer engine communicatively coupled to the physical channel, wherein the block transfer engine includes a buffer to allocate a plurality of virtual channels to the physical channel and to transfer a plurality of different address-overlapping blocks of data asynchronously and simultaneously using the virtual channels.

2. The computerized system of claim 1, wherein the network target is a second processing node, wherein the first processing node is configured to execute a first process and the second processing node is configured to execute a second process, and wherein the block transfer engine is configured to transfer data associated with a message from the first process to the second process using a virtual channel.

3. The computerized system of claim 2, wherein the second process at the network target is configured to pre-allocate a buffer to receive the data associated with the message, and wherein the virtual channel is configured to drop the data when no buffer is allocated when the data arrives at the network target.

4. The computerized system of claim 2, wherein the block transfer engine is configured to transfer the data associated with the message to a target, wherein the target is specified by the first process as a network endpoint without a target address.

5. The computerized system of claim 1, wherein the block transfer engine includes a channel transfer descriptor table for each virtual channel, wherein a channel transfer descriptor table describes a block transfer for a virtual channel and is accessed by at least one of a block transfer controller included in the block transfer engine or a process executing at the first processing node.

6. The computerized system of claim 5, wherein the virtual channel is configured with the channel descriptor table.

7. The computerized system of claim 1, wherein the block transfer engine includes a channel transfer descriptor table partitioned among the virtual channels, and wherein a respective virtual channel is configured with a respective channel transfer descriptor table partition.

8. The computerized system of claim 1,
wherein the network target includes a memory remote from the processing node,
wherein the block transfer engine asynchronously transfers respective blocks of data over respective virtual channels between the processing node and the remote memory according to respective channel descriptor tables included in the block transfer engine, and
wherein address ranges of the blocks of data overlap in the remote memory.

9. The computerized system of claim 8, wherein the block transfer engine is configured to allocate at least one of a block transfer controller or a packet generator to each virtual channel.

10. The computerized system of claim 8, wherein the block transfer engine includes:
a block transfer controller and a packet generator for each virtual channel, wherein the block transfer engine is configured to:
transfer the blocks of data in packets; and
complete the block transfers in a sequence different from a sequence in which the block transfers were initiated.

11. The computerized system of claim 1, wherein the block transfer engine includes:
an arbiter configured to arbitrate access of the virtual channels to the physical channel; and
wherein a virtual channel includes a buffer to store a request for access to the virtual channel when the virtual channel receives simultaneous requests for access.

12. The computerized system of claim 1, wherein the network target includes a system global memory remote from the first processing node.

13. A method of moving data in a computerized system, the method comprising:
providing a physical channel to transfer data between a memory local to a processing node and a target remote from the processing node;
allocating a plurality of virtual channels to the physical channel; and
asynchronously and simultaneously transferring a plurality of different address-overlapping blocks of data to the target using the virtual channels.

14. The method of claim 13, wherein asynchronously transferring data includes asynchronously transferring data for inter-kernel messaging in a multi-kernel system.

15. The method of claim 14, wherein asynchronously transferring data for inter-kernel messaging includes placing data associated with a kernel message in a pre-allocated buffer at the target, and dropping data if no buffer is allocated when the data arrives at the target.

16. The method of claim 15, wherein placing data associated with a kernel message in a pre-allocated buffer includes placing data in a pre-allocated buffer indicated by a network endpoint for the target instead of a target address.

17. The method of claim 13, wherein allocating a plurality of virtual channels includes assigning a channel descriptor table to each virtual channel, wherein a channel descriptor table describes a block transfer over a virtual channel and is accessed by at least one of a process or a block transfer controller.

18. The method of claim 17, including configuring the virtual channel with the channel descriptor table.

19. The method of claim 13, wherein allocating a plurality of virtual channels includes partitioning a channel descriptor table among the virtual channels, wherein the channel descriptor table describes a block transfer over a virtual channel and is accessed by at least one of a process or a block transfer controller.

20. The method of claim 13,
wherein the target includes a memory remote from the processor,
wherein asynchronously transferring data includes asynchronously transferring respective blocks of data over respective virtual channels between the processor and the remote memory, and
wherein address ranges of the data blocks overlap in the remote memory.

21. The method of claim 20, wherein allocating a plurality of virtual channels includes allocating at least one of a block transfer controller or a packet generator for each virtual channel.

22. The method of claim 20, wherein the blocks of data are transferred in packets, and wherein asynchronously transferring data includes completing the block transfers in a sequence different from a sequence in which the block transfers were initiated.

23. The method of claim 13, including:
arbitrating access of the virtual channels to the physical channel; and
storing a request for a virtual channel when the virtual channel receives simultaneous requests for access to the virtual channel.

24. The computerized system of claim 1, wherein each virtual channel includes at least a portion of a channel descriptor table, and wherein a virtual channel is configured using information in the channel descriptor table.
